(19) United States
(12) Patent Application Publication
(10) Pub. No.: US 2020/0076214 A1
(43) Pub. Date: Mar. 5, 2020

(54) DETACHABLE, HOT SWAPPABLE POWER MODULE WITH COMMUNICATION, REMOTE MONITORING, CONFIGURATION, AND CONTROL MEANS

(71) Applicant: Bernard Mifsud, Salfords (GB)

(72) Inventor: Bernard Mifsud, Salfords (GB)

(21) Appl. No.: 16/534,953

(22) Filed: Aug. 7, 2019

(30) Foreign Application Priority Data
Aug. 7, 2018 (GB) 1812853.8

(51) Int. Cl. H02J 7/00; H04W 4/80

(52) U.S. Cl. CPC H02J 7/0045; H02J 2007/0098; H04W 4/80; H02J 7/0026

(57) ABSTRACT

A smart power module having a plurality of external connectivity pins; one or more rechargeable battery cells; a control and processing unit; one or more communication means; one or more sensory means; wiring that interconnects all of the above; and a housing enclosing all of the above. The smart power module includes wireless communication means arranged to connect to a network or the internet and stream data acquired from the sensory means. A system includes the smart power module and a control server arranged to communicate with the smart battery via a network or the Internet.

### BACKGROUND

### Technical Field

This disclosure relates to a mobile power module. More specifically, the disclosure relates in particular to smart networkable batteries.

### Description of the Related Art

Some rechargeable battery products are fitted into power delivery systems, or equipment, that have the capability of interrogating the battery status. This equipment, by virtue of its own ability to connect wirelessly, can communicate information concerning the battery through a wireless communication network, to the cloud/internet or otherwise, so that battery performance information can be collected, analyzed and displayed as required. This is typical of the systems on the market today. Power system manufacturers have integrated wireless communication hardware directly into their system to become independent to third party equipment for wireless communication.

Although these means of communication addresses the majority of fixed battery solutions, when the battery or Power Module is of a Hot-Swap configuration, whereby the user can remove depleted batteries and replace them with fully charged batteries without the interruption of power, the status or condition of the removed battery is no longer accessible wirelessly. In some cases, these batteries are misplaced, stored inappropriately or are not recharged according to manufacturers' recommendations. In such cases, the life span of the battery is compromised and if left to discharge beyond a specific point, charging will not be possible due to safety reasons.

Since these batteries are of significant capacity, they represent a significant investment. Like other assets, the ability to track batteries remotely would be of significant value; furthermore, by allowing the batteries, even whilst they are removed from any equipment in both Hot-Swap applications or otherwise, the unique ability to transmit and receive data wirelessly, allows for battery maintenance, routine and preventative, to be actioned at any time based on factors that could affect the battery condition while disconnected from its equipment, for example, if left in direct sunlight or dropped. This ability is there to provide the best possible mechanism to ensure an extended life span.

The inventors' research shows that there are no smart batteries with their own wireless communication connection, that can communicate their status wirelessly and independently. Mostly the status of the battery would be communicated via the equipment it was installed in, or attached to. The wireless communication means may also be used for asset location, remote programming and safety alerting.

In finding ways to address this issue, the inventors propose that the best solution is to integrate independent wireless communication hardware into the battery, (or Power Module). By virtue of the battery storing power, as long as there is power stored in the battery, the battery becomes a communication device in its own right, i.e., it can connect and communicate with the cloud directly using a wireless communication network. Even if it is disconnected from the power system, i.e., sitting in a box in storage somewhere, or under the nurse's desk, or in a drawer.

### BRIEF SUMMARY

A first aspect of the disclosure provides a smart power module comprising:
a plurality of external connectivity pins;
one or more rechargeable battery cells;
a control and processing unit;
one or more communication means;
one or more sensory means arranged to acquire data;
wiring that interconnects all of the above; and
a housing enclosing all of the above.

The smart power module, may further comprise wireless communication means arranged to connect to a network or the internet and stream data acquired from the sensory means.

Wherein the communication means may be one or a combination of Wi-Fi, Bluetooth, Bluetooth Low Energy, NFC or other such wireless communication methods and protocols.

The one or more sensory means may be arranged to acquire data for:
temperature,
charge level,
load current,
shock, e.g., via an accelerometer,
humidity,
pressure,
voltage,
current,
battery statistics, including cycle count, health, etc.

The smart power module may further comprise means and arranged to:
receive Over The Air (OTA) updates for:
   bug fixes,
   change operating parameters,
   add new features;
connect to smartphones or tablets, for example, to facilitate the retrieval, monitoring, or configuration of the device;
determine its location through the use of location beacons or access points;
communicate with other parts of the system wirelessly when attached, or detached;

Wherein the connectivity pins provide input charging connections for the battery, as well as output connections from the battery to an electronic device coupled for providing power to.

The smart power module above wherein the control and processing unit manages the communications and the data acquisition.

The smart power module may further comprise memory and data storing means.

The smart power module may further comprise sensors to measure various electrical, mechanical and environmental conditions.

The smart power module may further comprise visual and audible indication means to display various conditions or act as a visual or audible alert.

The smart power module may further comprise built-in electrical and electronic protection for overcurrent, overvoltage, overcharge, over-temperature, short current, etc.

The smart power module may further comprise one or more buttons for user interactions.

The smart power module may further comprise a handle for easy handling when detached.

The smart power module may further comprise a locking mechanism to prevent unwanted detachment.

A second aspect of the disclosure provides a system comprising the smart power module of all of the above claims; a control server arranged to communicate with the smart battery via a network and/or the internet.

### BRIEF DESCRIPTION OF THE SEVERAL VIEWS OF THE DRAWINGS

The disclosure will now be described by way of example only with reference to the accompanying drawings in which:

FIG. 1 shows an illustration of components of a device in accordance with the disclosure;

FIG. 2 shows an illustration of a system in accordance with the disclosure.

### DETAILED DESCRIPTION

The disclosure describes a smart power module or smart standalone battery pack that comprises one or more sensors and communication means. The power module is able to communicate directly, and broadcast the readings of the sensors over the internet, as well as receive instructions from a central control server. The power module may be removable and swappable. The power module may be for use inside an electronic device or as an external attachable and detachable power module to an electronic device. An electronic device may be any device or system that requires electrical power to operate. The electronic device may be for domestic use, for industrial, medical, military, etc.

In this description, the smart power module may alternatively and interchangeably be referred to simply as the module, the battery, the battery pack, the smart battery and/or the battery module.

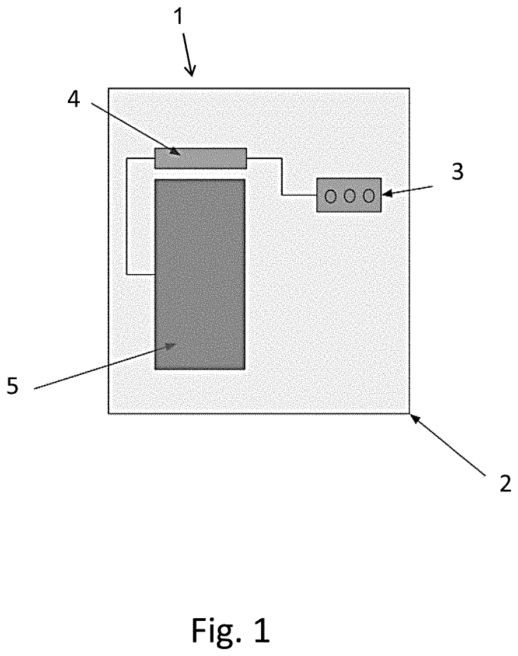

FIG. 1 illustrates a smart battery 1 and some of its components in accordance with the disclosure. The smart battery 1 comprises a housing 2, which houses all of the components of the smart battery, including electrical power source, sensors and communication means.

The battery 1 comprises a plurality of external connectivity pins 3 attached to the housing 2. The connectivity pins 3 may provide input charging connections for the battery, as well as output connections from the battery to an electronic device that it may couple for providing power. The connectivity pins 3 may further be for wired communications, e.g., serial port, Rx Tx, USB or the like for providing the smart battery e.g., with a firmware update, status check, or the like.

The battery 1 further comprises a control and processing unit 4. The control and processing unit 4 may comprise a controller, circuitry, sensors, communication means and wireless circuitry, battery gauge indicators, cell balance protection, location tracking means, such as Global Positioning System (GPS), or location identification via wireless communications, including Wi-Fi, Bluetooth, Near Field Communications (NFC), etc.

The battery 1 further comprises one or more battery cells 5. The battery cells 5 are rechargeable and hot swappable. The battery cells 5 may comprise sensors such as temperature sensors e.g., negative temperature coefficient (NTC) thermistors or the like.

The battery cells 5, the control and processing unit 4 and the connectivity pins 2 are interconnected via wires and circuitry inside the housing 2. The housing 2 may be water resistant and or waterproof and adhere to various Ingress Protection IPX standards.

The inventors' research shows that there are no smart batteries with their own wireless communication connection, that can communicate their status wirelessly and independently. Mostly the status of the battery would be communicated via the equipment it was installed in, or attached to. The wireless communication means may also be used for asset location, remote programming and safety alerting.

In finding ways to address this issue, the inventors propose that the best solution is to integrate independent wireless communication hardware into the battery. By virtue of the battery storing power, as long as there is power stored in the battery, the battery becomes a communication device in its own right, i.e., it can connect and communicate with the cloud directly using a wireless communication network. Even if it is disconnected from the power system, i.e., sitting in a box in storage somewhere, or under the nurse's desk, or in a drawer.

The control and processing unit 4 may comprise wireless communication means. Thus the smart battery 1 in addition to the main power system, may stream data independently while the system is in operation. The battery information does not need to be processed by the power system as both parts of the system can communicate in parallel, and as required, with the information being reconstituted in the cloud if necessary.

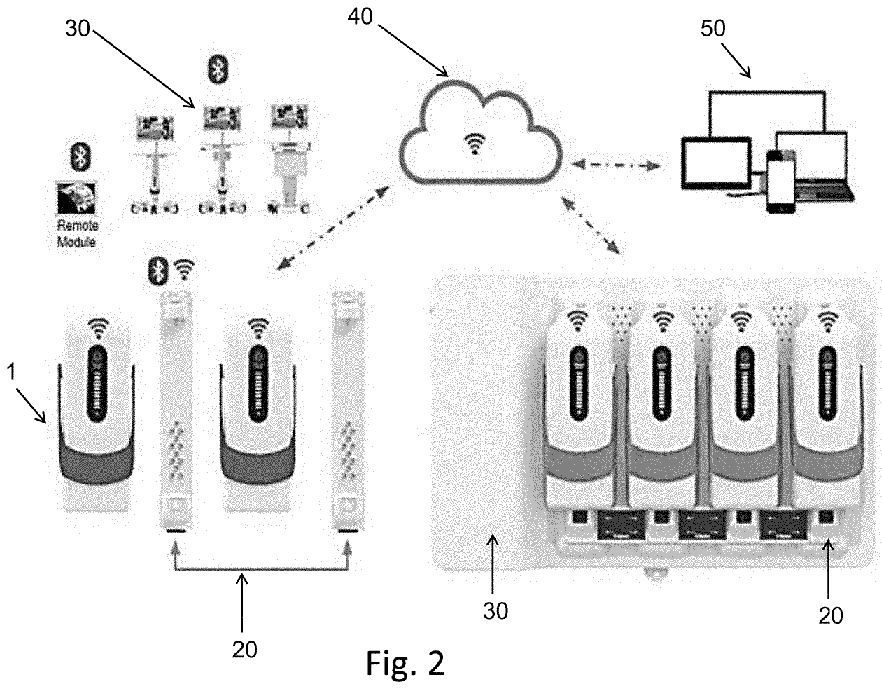

FIG. 2 illustrates a system comprising the smart battery 1. The smart battery 1 is an external attachable and detachable to a dock 20. The dock 20 is part of an electronic device 30, such as the one illustrated in FIG. 2. There may be one or more smart batteries 1 that attach to the electronic device 30 via one or more docks 20.

The smart battery 1 may communicate wirelessly, e.g., via Bluetooth, Wi-Fi, or the like, with the internet 40 and/or with the dock 20 and/or with the electronic device 30.

A control server 50 communicates with the smart battery 1 via the internet 40.

The control server 50 may communicate with the smart battery 1 directly via wired and wireless protocols, without the need to connect to the internet, if they are in close and in wireless range.

The communication means may be able to determine whether a power module is connected to a piece of equipment that is powered off, which otherwise would not be possible, allowing equipment to be located when inadvertently stored out of sight and forgotten. Additionally, the smart battery 1 may “call home” in predefined time intervals e.g., every day, or every week with an update on its status.

In connection with the control and processing unit 4, and e.g., from a command from the control server 50, the power device 1 may activate an indicator such as sound from an internal bleeper or flashing LED to help locate the device.

The combination of the communication means with “location” services it would be possible for a power module to be located from this “call home” action. Therefore not only report on how the smart battery 1 is being used while attached to a piece of equipment, but also report on what it is doing, and where it is while it is not being used. This type of insight is needed to maintain the assets in peak condition, and better understand areas of improvement through better asset utilization.

Below are described some further features of the smart battery 1.

The smart battery 1 may be detachable or fixed to the electronic device it is powering.

In some embodiments the electronic device may further provide charge to the smart battery 1.

The smart battery 1 may comprise a variety of communication means or modules such as Wi-Fi/Bluetooth/Bluetooth Low Energy/NFC or other wireless communication methods and protocols not yet available.

The smart battery 1 may comprise Bluetooth Low Energy (BLE) module or NFC, meaning that it can connect and communicate directly with a standard electronic device such as a smartphone or a tablet, without the need to connect to the internet.

The smart battery 1 may use a combination of properties of the wireless methods, for example, BLE may be used for switching on combinations, when the smart battery is in sleep mode; then Wi-Fi with IP address access and protocol may be used when bandwidth is required for large data transfer; Bluetooth may be used for pairing as well as data transfer; and NFC may be used for proximity identification. The above communications means may be used in various numbers and combinations.

The smart battery 1 may comprise one or more built-in types of communication means. The key is that the battery has independent wireless communication.

The smart battery 1 may have the ability to locate a disconnected battery through the Wi-Fi and BLE modules within it.

The smart battery 1 can also be a battery that is normally fixed but could be transported, stored, handled while detached.

The system comprising the smart battery 1 may have the ability to automatically check its state and send reports while not docked, using the communications modules within it. Some information that can be communicated include (but are not restricted to); temperature, charge level, shock (via accelerometer), humidity, pressure, battery statics (include cycle count, health, etc.) or any sensor information included within the battery module.

When the smart battery 1 is detached, it becomes independent, so it has the capability to wirelessly communicate with other listening devices or control server, and may comprise one or more of the sensory means below, which data may be transmitted via the communication means:

1. Temperature

2. Charge level

3. Shock (via accelerometer)

4. Humidity

5. Pressure

6. Battery statistics include cycle count, health, etc.

7. Any sensor information included within the battery module.

The system comprising the smart battery 1 may have the ability to receive Over The Air (OTA) updates while it is not docked. Said feature allows to tackle a number of safety issues, send bug fixes, or to change operating parameters of significant benefit, for example, improved algorithms to extend battery life; the ability to send bug fixes, or to change the operating parameters is of significant benefit, more remedial and preventive.

The smart battery 1 may have memory and data storing means. The data may be buffered and stored while communication is unavailable.

The smart battery 1 may have one or more sensors to measure various electrical, mechanical and environmental conditions.

The smart battery 1 may have visual and audible function to display various conditions or act as a visual or audible alert.

The smart battery 1 may have built-in electrical and electronic protection for overcurrent, overvoltage, overcharge, over-temperature, short current, etc.

The smart battery 1 may have one or more buttons to allow for user interactions.

The smart battery 1 may have a handle for easy handling while the device is detached.

The smart battery 1 may have a locking mechanism to prevent unwanted detachment.

The smart battery 1 may have hard gold contacts at the plurality of external connectivity pins 3 for reliable connectivity.

Furthermore the smart battery 1 may:
automatically check its state and send reports while not docked, included by not limited to:
   Temperature
   Charge level
   Load current
   Shock (via accelerometer)
   Humidity,
   Pressure
   Battery statistics (include cycle count, health, etc.)
   or any sensor information included within the device.
receive Over The Air (OTA) updates for
   bug fixes
   change operating parameters
   add new features
connect to smartphones or tablets, for example, to facilitate the retrieval, monitoring, or configuration of the device
determine its location through the use of location beacons or access points.
communicate with other parts of the system wirelessly when attached, or detached.

Other variations and modifications will be apparent to the skilled person. Such variations and modifications may involve equivalent and other features which are already known and which may be used instead of, or in addition to, features described herein.

Features that are described in the context of separate embodiments may be provided in combination in a single embodiment. Conversely, features which are described in the context of a single embodiment may also be provided separately or in any suitable sub-combination.

It should be noted that the term “comprising” does not exclude other elements, the term “a” or “an” does not exclude a plurality, a single feature may fulfil the functions of several features recited in the claims and reference signs in the claims shall not be construed as limiting the scope of the claims. It should also be noted that the Figures are not necessarily to scale; emphasis instead generally being placed upon illustrating the principles of the present disclosure.

1. A smart power module, comprising:
a housing;
a plurality of external connectivity pins attached to the housing;
one or more rechargeable battery cells disposed in the housing;
a control and processing assembly disposed in the housing;
one or more communication devices disposed in the housing;
one or more sensors disposed in the housing and configured to acquire data; and
a plurality of wires electrically connected between the plurality of external connectivity pins, the control and processing assembly, the one or more communication devices and the one or more sensors.

2. The smart power module of claim 1, further comprising a wireless communication device arranged to connect to a network and stream data acquired from the sensors.

3. The smart power module of claim 2, wherein the wireless communication device includes at least one of a Wi-Fi, Bluetooth, Bluetooth Low Energy, or Near Field Communications device.

4. The smart power module of claim 1, wherein the one or more sensors are configured to acquire data corresponding to at least one of: temperature, charge level, load current, shock, humidity, pressure, voltage, current, and battery statistics, wherein battery statistics includes cycle count or health.

5. The smart power module of claim 1 wherein the one or more communication devices are configured to:
receive data corresponding to bug fixes, changes to operating parameters, and new features;
connect to smartphones or tablets to facilitate the retrieval, monitoring, or configuration of the smart power module; and
determine a location of the smart power module through location beacons or access points.

6. The smart power module of claim 1, wherein the plurality of external connectivity pins provide input charging connections for the one or more rechargeable battery cells, as well as output connections from the one or more rechargeable battery cells to an external electronic device coupled to the housing.

7. The smart power module of claim 1, wherein the control and processing assembly is configured to manage communications to and from the one or more communication devices and data acquisition by the one or more sensors.

8. The smart power module of claim 1, further comprising a memory and a data storage device.

9. The smart power module of claim 1, whereon the one or more sensors are configured to measure electrical, mechanical and environmental conditions.

10. The smart power module of claim 1, further comprising visual and audible indicators configured to output a visual or an audible alert.

11. The smart power module of claim 1, further comprising built-in electronic protection circuitry configured to prevent at least one of: overcurrent, overvoltage, overcharge, over-temperature, or short current.

12. The smart power module of claim 1 further comprising one or more buttons on the housing and in electronic communication with the control and processing assembly and configured to control the control and processing assembly in response to user input.

13. The smart power module of claim 1, further comprising a handle.

14. The smart power module of claim 1, further comprising a locking mechanism, the locking mechanism configured to prevent detachment from a dock.

15. A system, comprising:
a smart battery including:
a housing;
a plurality of external connectivity pins attached to the housing;
one or more rechargeable battery cells disposed in the housing;
a control and processing assembly disposed in the housing;
one or more communication devices disposed in the housing;
one or more sensors disposed in the housing and configured to acquire data; and
a plurality of wires electrically connected between the plurality of external connectivity pins, the control and processing assembly, the one or more communication devices and the one or more sensors; and
a control server configured to communicate with the smart battery via a network.

16. The system of claim 15 wherein the one or more communication devices are configured to communicate with the control server through on or more wireless communication protocols.

17. The system of claim 15 further comprising:
a dock, the smart battery configured to attach and detach from the dock.

18. The system of claim 17 wherein the one or more communication devices are configured to communicate with the dock via one or more wireless communication protocols.
